(19) United States
(12) Patent Application Publication
(10) Pub. No.: US 2026/0312277 A1
(43) Pub. Date: Oct. 8, 2026

(54) WATCH WITH SWITCHABLE MULTI-BAND ANTENNA CONFIGURATION

(71) Applicant: Garmin International, Inc., Olathe, KS (US)

(72) Inventor: Yaoxuan Han, Olathe, KS (US)

(21) Appl. No.: 19/460,631

(22) Filed: Jan. 27, 2026

Related U.S. Application Data
(60) Provisional application No. 63/749,775, filed on Jan. 27, 2025.

(51) Int. Cl. H01Q 1/27; G04G 17/04; G04G 21/04; H01Q 1/50

(52) U.S. Cl. CPC H01Q 1/273; G04G 17/04; G04G 21/04; H01Q 1/50

(57) ABSTRACT

An electronic device comprises a housing, a plurality of ground switches, and a lower housing antenna. The housing includes a circumferential side wall, a bezel positioned above an upper surface of the side wall, and a bottom plate positioned below a lower surface of the side wall. Each ground switch is configurable between the ground switch being open and the ground switch being closed and is positioned at a respective one of a plurality of locations along a perimeter of the bottom plate. Each ground switch makes an electrical connection between the bottom plate and electrical ground when the ground switch is closed. The lower housing antenna is formed by a respective one of a plurality of signal feeds and a respective one of a plurality of groups of the ground switches, with each signal feed being positioned at locations along the perimeter of the bottom plate.

### RELATED APPLICATIONS

The current patent application is a non-provisional utility patent application which claims priority benefit, with regard to all common subject matter, under 35 U.S.C. § 119 (e) of earlier-filed U.S. Provisional Application Ser. No. 63/749,775, entitled “WATCH WITH MULTI-BAND ANTENNA CONFIGURATION”; and filed Jan. 27, 2025. The Provisional Application is hereby incorporated by reference, in its entirety, into the current patent application.

### BACKGROUND

Wrist-worn electronic devices often include functionality that may be used to track a user's current location, distance traveled, velocity, and other performance metrics or data. A wrist-worn electronic device is typically utilized by people who are walking, jogging, running, biking, hiking, backpacking, camping, mountain climbing, geocaching, or the like. This functionality may be provided by receiving location signals from a satellite-based positioning system, such as the global navigation satellite system (GNSS). Location determining accuracy may be improved by receiving GNSS signals output on two frequency bands, such as the L1 and L5 bands for the global positioning system (GPS). In addition, such devices may communicate wirelessly with other electronic devices, systems, or networks to monitor the user's activities and their performance during the activities, upload and download data, receive messages and information, and so forth. The communication protocols utilized to transmit and receive information may include Bluetooth, Wi-Fi, or telecommunications, such as cellular, signaling protocols. Furthermore, such devices may communicate wirelessly using non-terrestrial network (NTN) communication when the device is in a remote area. Each type of communication requires an antenna configured to transmit and/or receive wireless signals at a particular frequency or frequency band.

### SUMMARY

Embodiments of the present technology provide a wrist-worn electronic device which includes an antenna that can be selectively switched to communicate wirelessly at up to four (4) different frequencies or frequency bands. The electronic device broadly comprises a housing, a plurality of ground switches, and a lower housing antenna. The housing includes a circumferential side wall, a bezel positioned above an upper surface of the side wall, and a bottom plate positioned below a lower surface of the side wall. The bezel and the bottom plate are each at least partially formed from electrically conductive material. Each ground switch is selectively configurable between a first state in which the ground switch is open and a second state in which the ground switch is closed and is positioned at a respective one of a plurality of ground locations along a perimeter of the bottom plate. Each ground switch is configured to make an electrical connection between the bottom plate and electrical ground when the ground switch is closed. The lower housing antenna is configured to operate at a respective one of a plurality of lower housing antenna frequencies. The lower housing antenna is formed at least in part by a respective one of a plurality of signal feeds and a respective one of a plurality of groups of the ground switches, with each signal feed being positioned at a respective one of a plurality of signal feed locations along the perimeter of the bottom plate.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF DRAWINGS

Embodiments of the present technology are described in detail below with reference to the attached drawing figures, wherein:

FIG. 1 is a perspective view of a wrist-worn electronic device, constructed in accordance with various embodiments of the current technology, including a selectively switchable antenna configuration;

FIG. 2 is a schematic block diagram illustrating electronic communication between various components of the electronic device;

FIG. 3 is a schematic block diagram of a ground switch coupled to a tuning network;

FIG. 4 is a bottom view of the electronic device (excluding a wrist band) illustrating locations of a respective one of a plurality of signal feeds and a respective one of a plurality of ground switches;

FIG. 5A is a table listing a plurality of ground switch settings for each of a plurality of characteristics modes of a first embodiment of a lower housing antenna;

FIG. 5B is a schematic diagram of a bottom plate of the electronic device with the signal feeds and the ground switches, illustrating a plurality of signal paths for a first characteristic mode of the first embodiment of the lower housing antenna;

FIG. 5C is a schematic diagram of the bottom plate of the electronic device with the signal feeds and the ground switches, illustrating the signal paths for a second characteristic mode of the first embodiment of the lower housing antenna;

FIG. 5D is a schematic diagram of the bottom plate of the electronic device with the signal feeds and the ground switches, illustrating the signal paths for a third characteristic mode of the first embodiment of the lower housing antenna;

FIG. 5E is a schematic diagram of the bottom plate of the electronic device with the signal feeds and the ground switches, illustrating the signal paths for a fourth characteristic mode of the first embodiment of the lower housing antenna;

FIG. 6A is a table listing a plurality of ground switch settings for each of a plurality of characteristics modes of a second embodiment of the lower housing antenna;

FIG. 6B is a schematic diagram of a bottom plate of the electronic device with the signal feeds and the ground switches, illustrating a plurality of signal paths for a first characteristic mode of the second embodiment of the lower housing antenna;

FIG. 6C is a schematic diagram of the bottom plate of the electronic device with the signal feeds and the ground switches, illustrating the signal paths for a second characteristic mode of the second embodiment of the lower housing antenna;

FIG. 7A is a table listing a plurality of ground switch settings for each of a plurality of characteristics modes of a third embodiment of the lower housing antenna;

FIG. 7B is a schematic diagram of a bottom plate of the electronic device with the signal feeds and the ground switches, illustrating a plurality of signal paths for a first characteristic mode of the third embodiment of the lower housing antenna;

FIG. 7C is a schematic diagram of the bottom plate of the electronic device with the signal feeds and the ground switches, illustrating the signal paths for a second characteristic mode of the third embodiment of the lower housing antenna;

FIG. 8A is a table listing a plurality of ground switch settings for each of a plurality of characteristics modes of a fourth embodiment of the lower housing antenna;

FIG. 8B is a schematic diagram of a bottom plate of the electronic device with the signal feeds and the ground switches, illustrating a plurality of signal paths for a first characteristic mode of the fourth embodiment of the lower housing antenna; and

FIG. 8C is a schematic diagram of the bottom plate of the electronic device with the signal feeds and the ground switches, illustrating the signal paths for a second characteristic mode of the fourth embodiment of the lower housing antenna.

The drawing figures do not limit the present technology to the specific embodiments disclosed and described herein. The drawings are not necessarily to scale, emphasis instead being placed upon clearly illustrating the principles of the technology.

### DETAILED DESCRIPTION OF THE TECHNOLOGY

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the present technology. The following detailed description is, therefore, not to be taken in a limiting sense. The scope of the present technology is defined only by the appended claims, along with the full scope of equivalents to which such claims are entitled.

In the following description, the word “voltage” may be used to describe electric voltage, the word “current” may be used to describe electric current, and the word “power” may be used to describe electric power. In addition, the term “signal” or “electronic signal” may be used to describe an electromagnetic wave conducted through an electrically conductive medium in which a voltage and/or a current varies, or may be constant, over time.

Relational and/or directional terms, such as “above”, “below”, “up”, “upper”, “upward”, “down”, “lower”, “downward”, “top”, “bottom”, “outer”, “inner”, “left”, “right”, etc., along with orientation terms, such as “horizontal” and “vertical”, may be used throughout this description. These terms retain their commonly accepted definitions and are used with reference to embodiments of the technology and the positions, directions, and orientations thereof shown in the accompanying figures. However, embodiments of the technology in practice may be positioned and oriented in other ways or move in other directions. Therefore, the terms do not limit the scope of the current technology.

Wrist-worn electronic devices often include functionality that may be used to track a user's current location, distance traveled, velocity, and other performance metrics or data. A wrist-worn electronic device is typically utilized by people who are walking, jogging, running, biking, hiking, backpacking, camping, mountain climbing, geocaching, or the like. This functionality may be provided by receiving location signals from a satellite-based positioning system, such as the global navigation satellite system (GNSS). Location determining accuracy may be improved by receiving GNSS signals output on two frequency bands, such as the L1 and L5 bands for the global positioning system (GPS). In addition, such devices may communicate wirelessly with other electronic devices, systems, or networks to monitor the user's activities and their performance during the activities, upload and download data, receive messages and information, and so forth. The communication protocols utilized to transmit and receive information may include Bluetooth, Wi-Fi, or telecommunications, such as cellular, signaling protocols. Furthermore, such devices may communicate wirelessly using non-terrestrial network (NTN) communication when the device is in a remote area. Each type of communication requires an antenna configured to transmit and/or receive wireless signals at a particular frequency or frequency band. Constructing an electronic device that is worn on the user's wrist and has the capability to communicate through multiple protocols presents a challenge for the antenna design.

Embodiments of the present technology provide a wrist-worn electronic device which includes a plurality of antennas that establish communication through a plurality of protocols using multiple frequencies. The electronic device includes a first antenna which utilizes upper housing components such as an electrically conductive bezel to provide communication at one or more frequencies. The electronic device further includes a second antenna which utilizes lower housing components such as an electrically conductive bottom plate, a plurality of signal feeds, and a plurality of ground switches to provide communication at up to four (4) frequencies which may allow communication through four (4) different protocols. The frequency of communication may be selected by utilizing one or more of the signal feeds and closing various combinations of the ground switches which create various pathways along the bottom plate for the signal to travel.

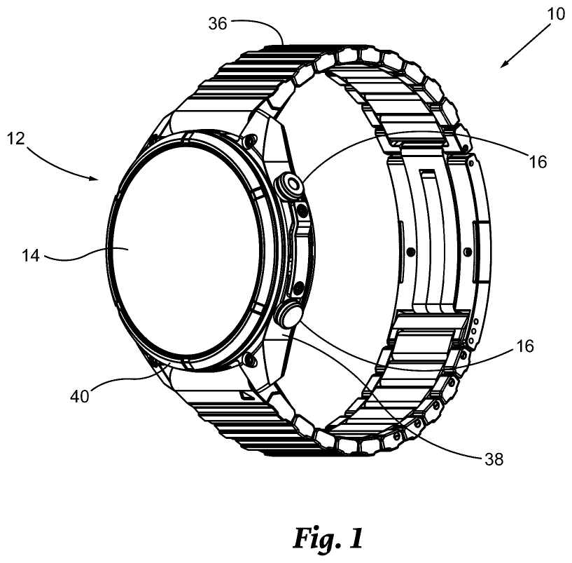

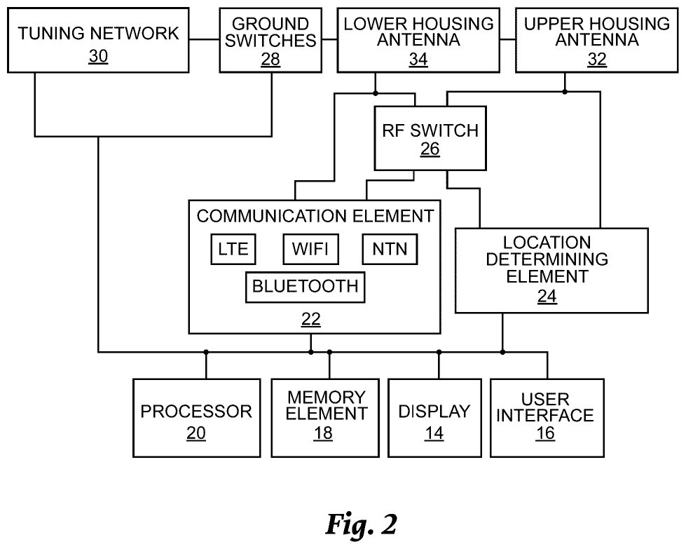

Embodiments of the technology will now be described in more detail with reference to the drawing figures. Referring initially to FIGS. 1 and 2, a wrist-worn electronic device 10 is illustrated. The electronic device 10 broadly comprises a housing 12, a display 14, a user interface 16, a memory element 18, a processor 20, a communication element 22, a location determining element 24, a radio frequency (RF) switch 26, a plurality of ground switches 28, a plurality of tuning networks 30, an upper housing antenna 32, and a lower housing antenna 34. The electronic device 10 may also include a wrist band 36, a strap, or other attachment mechanisms. In addition, communication between various electronic components of the electronic device 10 is illustrated schematically in FIG. 2.

The housing 12 generally houses or retains other components of the electronic device 10 and may include or be coupled to the wrist band 36. The housing 12 may include at least one side wall 38, a bezel 40, and a bottom plate 42. In exemplary embodiments that are shown in the figures, the housing 12 includes a single side wall 38, with inner and outer surfaces, an upper surface or edge, and a lower surface or edge. The side wall 38 has a circular or ring shape which generally forms a hollow cylinder. In other embodiments, the side wall 38 may have an oval or elliptical shape. In still other embodiments, the housing 12 may include a plurality of side walls 38 which form one of a plurality of geometric or polygonal shapes, such as triangular, square or rectangular, hexagonal, octagonal, and so forth. In exemplary embodiments, the side wall 38 further includes one or more through holes extending from the inner surface to the outer surface. Components of the user interface 16 may be positioned in the through holes.

The bezel 40 is positioned above the upper surface of the side wall 38. In some embodiments, the bezel 40 may be coupled to the upper surface of the side wall 38. In other embodiments, the bezel 40 may be coupled to an electrically insulating ring which is coupled to the upper surface of the side wall 38. The bezel 40 is generally annular shaped with a circular aspect and has a central opening through which the display 14 is visible and may, itself, retain a lens or other components that cover the display 14. The bezel 40 is formed from electrically conductive materials, such as metals and/or metal alloys, which are electromagnetically radiating.

The bottom plate 42 is positioned beneath the lower surface of the side wall 38 and generally conforms to the shape of the side wall 38. Thus, exemplary embodiments of the bottom plate 42 have a circular or disc shape. In some embodiments, the bottom plate 42 may be coupled to the lower surface of the side wall 38. In other embodiments, the bottom plate 42 may be coupled to an electrically insulating ring which is coupled to the upper surface of the side wall 38. The bottom plate 42 includes a lower, outer surface that contacts the user's wrist while the user is wearing the electronic device 10. The bottom plate 42 is formed from electrically conductive materials, such as metals and/or metal alloys, which are electromagnetically radiating.

The display 14 may include video devices of the following types: light-emitting diode (LED), organic LED (OLED), Light Emitting Polymer (LEP) or Polymer LED (PLED), liquid crystal display (LCD), thin film transistor (TFT) LCD, or the like, or combinations thereof. The display 14 may include a screen on which information is presented, with the screen possessing any one of a variety of shapes, such as a square or a rectangular aspect ratio that may be viewed in either a landscape or a portrait mode. In some embodiments, the display 14 may further include a lens overlying the viewing area, which may enhance the visibility of the information shown on the display 14. In various embodiments, the display 14 may also include a touch screen occupying the entire screen or a portion thereof so that the display 14 functions as part of the user interface 16. The touch screen may allow the user to interact with the electronic device 10 by physically touching, swiping, or gesturing on areas of the screen. The display 14 may be in electronic communication with the memory element 18 and the processor 20 and may receive data or information therefrom that is to be shown on the display 14.

The user interface 16 generally allows the user to directly interact with the electronic device 10 and may include pushbuttons, rotary knobs, or the like. In the exemplary embodiment of FIG. 1, the housing 12 may include one or more pushbuttons and/or rotary knobs located in the through holes of the side wall 38 that function as at least a portion of the user interface 16. The user interface 16 may allow the user to scroll through menus or change screens in order to control the function or operation of the electronic device 10.

The memory element 18 may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, optical disks, flash memory, thumb drives, universal serial bus (USB) drives, solid state memory, solid state drives (SSDs), or the like, or combinations thereof. In some embodiments, the memory element 18 may be embedded in, or integrated in the same package as, the processor 20. The memory element 18 may include, constitute, or embody, a non-transitory “computer-readable medium”. The memory element 18 may store the instructions, code, code statements, code segments, software, firmware, programs, applications, apps, services, daemons, or the like that are executed by the processor 20. The memory element 18 is in electronic communication with the processor 20 and may also store data that is received by the processor 20 or the device in which the processor 20 is implemented. The processor 20 may further store data or intermediate results generated during processing, calculations, and/or computations as well as data or final results after processing, calculations, and/or computations. In addition, the memory element 18 may store settings, lookup tables, text data, documents from word processing software, spreadsheet software and other software applications, sampled audio sound files, photograph or other image data, movie data, databases, and the like.

The processor 20 may comprise one or more processors that include electronic hardware components such as microprocessors (single-core or multi-core), microcontrollers, digital signal processors (DSPs), field-programmable gate arrays (FPGAs), analog and/or digital application-specific integrated circuits (ASICs), or the like, or combinations thereof. The processor 20 may further include system on a chip (SoC) architectures. The processor 20 may generally execute, process, or run algorithms, instructions, code, code segments, code statements, software, firmware, programs, applications, apps, processes, services, daemons, or the like. The processor 20 may also include hardware components such as registers, finite-state machines, sequential and combinational logic, configurable logic blocks, and other electronic circuits that can perform the functions necessary for the operation of the current technology. In certain embodiments, the processor 20 may include multiple computational components and functional blocks that are packaged separately but function as a single unit. In some embodiments, the processor 20 may further include multiprocessor architectures, parallel processor architectures, processor clusters, and the like, which provide high performance computing. The processor 20 may be in electronic communication with the other electronic components of the electronic device 10 through serial or parallel links that include universal busses, address busses, data busses, control lines, and the like. In addition, the processor 20 may include analog to digital converters (ADCs) to convert analog electronic signals to digital data values in binary form (such as by sampling), or streams of digital data values, and/or digital to analog converters (DACs) to convert digital data values, or streams of digital data values, to analog electronic signals.

The processor 20 is operable, configured, programmed, and/or trained to perform the functions, operations, processes, methods, and/or algorithms of the electronic device 10 by utilizing hardware, software, firmware, or combinations thereof. Other components, such as the communication element 22 and the memory element 18 may be utilized as well.

The processor 20 outputs a plurality of control signals which control the operation of various components of the electronic device 10. For example, the processor 20 may output a plurality of control signals, wherein each control signal is received by a respective one of the ground switches 28. The control signal determines the state, open or closed, of the ground switch 28. The processor 20 may also output a plurality of control signals, wherein each control signal is received by a respective one of the tuning networks 30. The control signal enables or disables the tuning network 30 and may select the frequency at which the tuning network 30 tunes or filters.

In various embodiments, the tuning networks 30 may be arranged on a per-switch basis or may be shared among multiple ground switches 28. For example, a tuning network 30 may be electrically coupled in association with an individual ground switch 28, or a tuning network 30 may be electrically coupled with a subset (group) of the ground switches 28 such that the subset (group) is tuned (or filtered) for a selected resonant frequency when the corresponding ground switches 28 are closed. “Subset” and “group” are used interchangeable herein. In further embodiments, different tuning networks 30 may be coupled with different subsets of the ground switches 28 and tuned (or filtered) to different resonant frequencies, thereby enabling the lower housing antenna 34 to support operation at multiple resonant frequencies using different subsets of the ground switches 28. The processor 20 may provide control signals to selectively enable/disable and/or adjust the tuning networks 30 and to set the states of the ground switches 28 to establish the desired operating frequency or frequencies.

The communication element 22 generally allows the electronic device 10 to communicate with other computing devices, external systems, computing networks, telecommunication networks, the Internet, and the like. The communication element 22 may include signal and/or data transmitting and receiving circuits, such as amplifiers, filters, mixers, oscillators, digital signal processors (DSPs), and the like. The communication element 22 may establish communication wirelessly by utilizing radio frequency (RF) signals and/or data that comply with communication standards such as cellular 2G, 3G, 4G, Voice over Internet Protocol (VOIP), or 5G, Institute of Electrical and Electronics Engineers (IEEE) 802.11 standard such as WiFi, IEEE 802.16 standard such as WiMAX, Bluetooth™, or combinations thereof. Wireless signals that utilize WiFi and Bluetooth™ protocols may have a frequency of 2.4 gigahertz (GHz). The communication element 22 may also utilize communication standards such as ANT, ANT+, Bluetooth™ low energy (BLE), the industrial, scientific, and medical (ISM) band at 2.4 GHz, or the like. In addition, the communication element 22 may utilize standards which provide communication with long-term evolution (LTE) communication systems, including terrestrial wireless broadband communication networks and is a part of, or an extension of, the fourth generation (4G) telecommunication standard. The LTE frequency bands include various B bands (B1, B2, B3, B4, B8, B12, B20, B28, etc.) utilized in North America, Central America, South America, Europe, the Middle East, Africa, Asia, Australia, and New Zealand. Furthermore, the communication element 22 may utilize standards which provide communication with non-terrestrial network (NTN) systems including spaceborne platforms, such as low-earth orbit (LEO) satellites, medium-earth orbit (MEO) satellites, geosynchronous-earth orbit (GEO) satellites, etc., airborne platforms, such as airplanes, balloons, airships, etc., and air to ground networks such as terrestrial tower antennas to communicate with the spaceborne and airborne platforms as well as terrestrial networks. The NTN frequency bands include the NTN (n255) L band and the NTN (n256) S band, which range from approximately 700 MHz to approximately 2200 MHz. The communication element 22 may be in electronic communication with the memory element 18 and the processor 20. In addition, the communication element 22 may communicate electronic signals, for wireless transmitting and receiving, to and from the lower housing antenna 34 and, through the RF switch 26, to and from the upper housing antenna 32.

The location determining element 24 generally determines a current geolocation of the electronic device 10 and may receive and process radio frequency (RF) wireless signals, such as wireless location signals, output by satellites of a multi-constellation GNSS such as the global positioning system (GPS) utilized in the United States, the GLONASS system utilized in Russia, the Galileo system utilized in Europe, or the like. The location determining element 24 may include satellite navigation receivers, processors, controllers, other computing devices, or combinations thereof, and memory. The location determining element 24 receives and processes one or more location electronic signals from the upper housing antenna 32 and the lower housing antenna 34 (through the RF switch 26), which correspond to, and are derived from, one or more location wireless signals output by GNSS satellites. The location wireless signal includes data and information that the location determining element 24 is able to utilize to determine a current geolocation of the electronic device 10. An exemplary location wireless signal is output by GPS satellites and has a frequency in the GPS L1 band, which has a center frequency of approximately 1575 MHz. The location wireless signal may also include the GPS L5 signal, which has a center frequency of approximately 1175 MHz. The location determining element 24 can receive and utilize location signals output by GPS satellites in the GPS L1 band and/or GPS L5 band. With the data and information from location signals output by GPS satellites on both the GPS L1 band and the GPS L5 band, the location determining element 24 of the current technology is capable of determining the current geolocation of the electronic device 10 with greater accuracy than conventional devices that may only utilize location signals output by GPS satellites on the GPS L1 band alone. The location determining element 24 may communicate the determined current geolocation to the processor 20, store the determined current geolocation in the memory element 18, or both. Although the location determining element 24 of the current technology utilizes data and information from location signals output on both GPS L1 and L5 bands, it is within the scope of the current technology for the location determining element 24 to utilize data and information from two or more bands from other GNSS constellations, such as GLONASS or Galileo.

The RF switch 26 generally routes electronic signals between the lower housing antenna 34 and the location determining element 24 and between the upper housing antenna 32 and the communication element 22, according to the frequency of the electronic signals. The RF switch 26 may include active devices, such as bipolar junction transistors, field effect transistors, or the like, which are capable of conducting a high frequency electronic signal. Each active device may be selectively enabled or turned on by a voltage level or a current level. The RF switch 26 is in electronic communication with the upper housing antenna 32 and the lower housing antenna 34 and receives a plurality of electronic signals from each antenna, with each electronic signal having a frequency or frequency band. For example, the upper housing antenna 32 may communicate GPS electronic signals, LTE electronic signals, and Bluetooth™ electronic signals. The Bluetooth™ electronic signals may be routed through the RF switch 26 to the communication element 22. The lower housing antenna 34 may communicate LTE electronic signals and GPS electronic signals. The GPS electronic signals may be routed through the RF switch 26 to the location determining element 24.

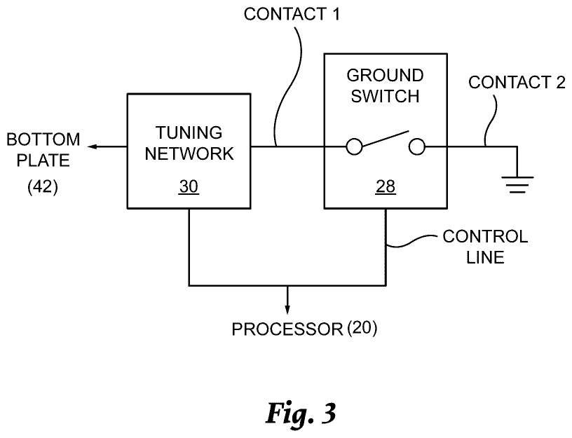

The ground switches 28 each provide selective electrical connection between the bottom plate 42 and electrical ground. Referring to FIG. 3, each ground switch 28 is a toggle or single-pole, single-throw type switch including a first contact, a second contact, and a control line, and having a first state that is open, in which there is no electrical connection between the first contact and the second contact, and a second state that is closed, in which there is electrical connection between the first contact and the second contact. The state of the ground switch 28 varies according to a binary value of the control line. For example, the ground switch 28 may be in the first state (open) when the control line has a value of “0” and in the second state (closed) when the control line has a value of “1”, or vice-versa. The ground switch 28 may be implemented using an active device, such as a bipolar junction transistor, a field effect transistor, or the like. The first contact of each ground switch 28 is electrically connected to the tuning network 30, and the second contact is electrically connected to electric ground. The control line receives a control (electronic) signal from the processor 20 which establishes the binary value, i.e., whether the ground switch 28 is open or closed.

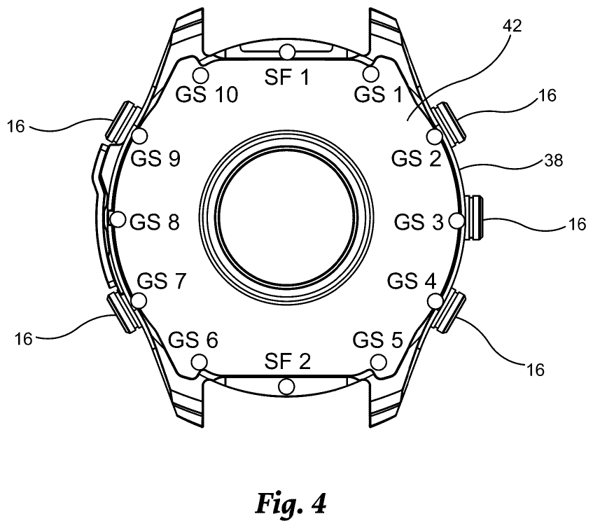

Referring to FIG. 4, exemplary embodiments of the electronic device 10 include ten (10) ground switches 28 (shown as “GS #” in FIG. 4, wherein “#” represents a number of the ground switch 28) positioned along the perimeter of the bottom plate 42 at a respective one of a plurality of ground locations, wherein each ground location corresponds to a respective one of the hourly positions on a clock face. For example, a first ground switch GS1 is positioned at 11 o'clock (accounting for the fact that the bottom plate 42 is viewed from its bottom surface, which is reversed from the top view), a second ground switch GS2 is positioned at 10 o'clock, and so forth through a fifth ground switch GS5, which is positioned at 7 o'clock. A sixth ground switch GS6 is positioned at 5 o'clock and so forth through a tenth ground switch GS10, which is positioned at 1 o'clock. Thus, the first five ground switches GS1-GS5 are positioned along a first half of the perimeter of the bottom plate 42, and the second five ground switches GS6-GS10 are positioned along a second half of the perimeter of the bottom plate 42.

In further embodiments, the lower housing antenna 34 may include more than two signal feeds, with three or more signal feeds positioned at respective locations along the perimeter of the bottom plate 42. The signal feed locations are not limited to diametrically opposed or evenly spaced positions and may be selected to optimize performance for particular characteristic modes or resonant frequencies. Likewise, the ground switches 28 need not be evenly spaced or symmetrically arranged along the perimeter of the bottom plate 42. In some embodiments, the ground switches 28 may be arranged in non-uniform or asymmetric distributions, clustered in selected regions of the perimeter, or positioned at locations that do not correspond to hourly positions on a clock face, while still being selectively controlled by the processor 20 to configure the lower housing antenna 34 for desired operating frequencies.

Each tuning network 30 generally provides filtering or tuning of an electronic signal to a particular frequency or a range of frequencies. The tuning network 30 may include passive electrical components, such as capacitors, inductors, and resistors, and/or active devices electrically connected to one another to form a high pass filter, a low pass filter, a band pass filter, a band cut filter, or the like. The tuning network 30 includes a first port and a second port, wherein the first port may conduct or communicate an unfiltered electronic signal and the second port may conduct or communicate a filtered or tuned electronic signal, and vice-versa. The first port may be electrically connected to the bottom plate 42 and the second port may be electrically connected to the ground switch 28. The tuning network 30 may further include a control line which may receive one or more control (electronic) signals which enable or disable the tuning network 30. When the tuning network 30 is disabled, the electronic signal may pass through the tuning network 30 without being filtered. The control signals may also selectively or dynamically adjust the tuning frequency or frequencies of the tuning network 30. The control signals may be received from the processor 20.

The upper housing antenna 32 and the lower housing antenna 34 each convert wireless RF electromagnetic radiation (a wireless signal) in a characteristic mode at one or more frequencies, i.e., one or more resonant frequencies, into a corresponding electronic signal and convert an electronic signal into a corresponding wireless signal. It is generally understood that characteristic modes analysis enables a radiating body, such as a structure of each antenna 32, 34, to be utilized or optimized in view of an understanding of a distribution of electrical current (I) and radiation of each of a plurality of modes. Characteristic modes are known to be a representation of a set of orthogonal real currents on the surface of the antenna 32, 34, depending on the shape and size of the antenna 32, 34 structure. Analysis and application of characteristic modes enables tuning of the antennas 32, 34 to desired resonant frequencies and determination of suitable locations to feed the antennas 32, 34 via generation of the modes, modal significance and distribution of surface currents, with use of conventional far field radiation patterns to further assist with the optimization process (i.e., characteristic modes analysis may assist with the determination of characteristic modes to form a desired far field radiation pattern). When applying characteristic modes to the antennas 32, 34, the electric and magnetic fields are linearly related to the electrical current and can be expressed in modal forms. A characteristic mode may be determined based on the structure of the antenna 32, 34 and a modal significance (MS), which is represented by the normalized amplitude of current modes, as indicated in EQ. 1:

$$MSn = \vert \frac{1}{1 + j λ n} \vert \qquad [ EQ . 1 ]$$

Modal significance is typically between values of 0 and 1, where a characteristic mode is at resonance when its modal significance is substantially equal to 1 (or as high of a modal significance as practicable under the circumstances), with a characteristic angle substantially equal to 180 degrees.

The upper housing antenna 32 and the lower housing antenna 34 each may operate, i.e., receive and/or transmit, in a range of characteristic modes or resonant frequencies from approximately 700 MHz to approximately 2.4 GHz. Accordingly, the antennas 32, 34 may be utilized to receive and/or transmit GPS L1 band and/or L5 band wireless signals, Bluetooth™ wireless signals, Wi-Fi wireless signals, LTE wireless signals, NTN wireless signals, and so forth.

The upper housing antenna 32 may be implemented as an inverted-F antenna, a patch antenna, a loop antenna, a slot antenna, or the like and may be formed at least in part by the bezel 40. In some embodiments, the upper housing antenna 32 is formed at least in part by an entire circumference of the bezel 40. In other embodiments, the upper housing antenna 32 is formed at least in part by one or more portions of the circumference of the bezel 40. In various embodiments, the upper housing antenna 32 may also include the side wall 38 or at least a portion of the circumference of the side wall 38. In certain embodiments, the upper housing antenna 32 may further include a printed circuit board (not shown in the figures) and electrical connectors which connect the printed circuit board to the bezel 40, the side wall 38, or both. Exemplary implementations of the upper housing antenna 32 that include at least a portion of the bezel 40 are described in more detail in U.S. application Ser. No. 19/278,514 (“WATCH HOUSING HAVING A RECEIVING STRUCTURE AND OUTER STRUCTURE ELEMENTS”) and Ser. No. 19/202,371 (“WATCH WITH ADJUSTABLE-LENGTH BIPLANAR ANTENNA CONFIGURATION”), each of which is incorporated by reference, in its entirety, into the current patent application, except where inconsistent with the teachings of the current patent application.

The lower housing antenna 34 may be implemented as an inverted-F antenna, a patch antenna, a loop antenna, a slot antenna, or the like and may be formed at least in part by the bottom plate 42. Referring to FIG. 4, in addition to the bottom plate 42, the lower housing antenna 34 includes and/or is formed by a first signal feed SF1, a second signal feed SF2, and the ten ground switches GS1-GS10, in various combinations. The first signal feed SF1 is positioned at a first location along the perimeter of the bottom plate 42, such as 12 o'clock, and the second signal feed SF2 is positioned at a second location along the perimeter of the bottom plate 42, such as 6 o'clock. Each signal feed SF1, SF2 may be in electronic communication with, or electrically connected to, the communication element 22, the location determining element 24, the RF switch 26, or combinations thereof. Furthermore, each of the signal feeds SF1, SF2 may include an electronic switch, similar to the ground switch 28 or the RF switch 26 and having a control line configured to open and close the switch, that selectively electrically connects the signal feed SF1, SF2 to the listed components.

The lower housing antenna 34 may operate in one of a plurality of modal significances or characteristic modes, which may be selected according to the combination of the signal feed SF1, SF2 and the closed ground switches GS1-GS10 that are utilized. When the lower housing antenna 34 is operating in a particular characteristic mode, it is able to, or configured to, transmit and/or receive wireless signals at one or more resonant frequencies. The resonant frequency at which the lower housing antenna 34 operates determines which types or communication protocols of wireless signals the lower housing antenna 34 can transmit and/or receive. For example, if the lower housing antenna 34 is operating at a resonant frequency of approximately 2.4 GHz, then the lower housing antenna 34 may transmit and/or receive wireless signals having WiFi and Bluetooth™ protocols. If the lower housing antenna 34 is operating at a resonant frequency of approximately 700 MHz, then the lower housing antenna 34 may transmit and/or receive wireless signals having LTE B12 band protocols. If the lower housing antenna 34 is operating at a resonant frequency of approximately 1176.45 MHz, then the lower housing antenna 34 may or receive wireless signals having GPS L5 band protocols, and so forth.

In certain embodiments, the lower housing antenna 34 may be configured to operate at two or more resonant frequencies simultaneously. In such embodiments, different signal feeds SF1, SF2 and different groups of the ground switches GS1-GS10 may be concurrently enabled, and corresponding tuning networks 30 may be simultaneously enabled and tuned to different resonant frequencies. As a result, the lower housing antenna 34 may support concurrent transmission and/or reception of wireless signals at multiple resonant frequencies within a single operating state, rather than operating in only a single characteristic mode at a time. The processor 20 may output control signals to the signal feeds SF1, SF2, the ground switches 28, and the tuning networks 30 to establish and maintain such simultaneous multi-frequency operation.

The electronic device 10 may operate in a certain functional mode, as selected by the user or as required with some operating system processes, which requires a certain communication protocol and frequency of operation for the lower housing antenna 34. For example, the user may wish to pair the electronic device 10 with a heart rate monitor using Bluetooth™. Accordingly, the lower housing antenna 34 should be configured to operate in a characteristic mode that allows for Bluetooth™ communication. The processor 20 retrieves the settings from the memory element 18 for the signal feeds SF1, SF2 and the ground switches GS1-GS10 that configure the lower housing antenna 34 to operate in a characteristic mode allowing for Bluetooth™ communication. The processor 20 outputs the settings as control signals on the control lines to the signal feeds SF1, SF2 and the ground switches GS1-GS10. The control signals open or close the respective switch associated with each signal feed SF1, SF2 and open or close each of the ground switches GS1-GS10.

In some embodiments, the processor 20 may dynamically adjust operation of the lower housing antenna 34 during use of the electronic device 10. For example, the processor 20 may modify the states of the ground switches 28 and adjust or retune one or more of the tuning networks 30 in response to changing operating conditions, such as movement of the electronic device 10, changes in orientation relative to the user's body, or changes in a surrounding electromagnetic environment. By dynamically updating the configuration of the signal feeds SF1, SF2, the ground switches 28, and the tuning networks 30, the processor 20 may maintain or improve antenna performance across one or more operating frequencies.

In various embodiments, the processor 20 may determine one or more required operating frequencies for the lower housing antenna 34 based on a selected functional mode of the electronic device 10, a selected communication protocol, or both. The processor 20 may select, from data stored in the memory element 18, a corresponding configuration that maps each required operating frequency to specific signal feeds SF1, SF2, ground switches 28, and tuning networks 30. The processor 20 may then output control signals to set the states of the ground switches 28, to enable or disable the tuning networks 30, and to adjust the tuning frequency or frequencies of the tuning networks 30, such that the lower housing antenna 34 operates at the one or more required operating frequencies.

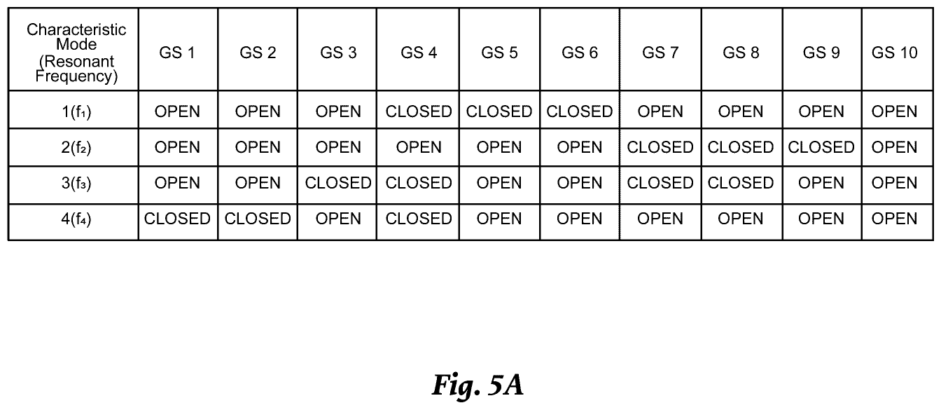

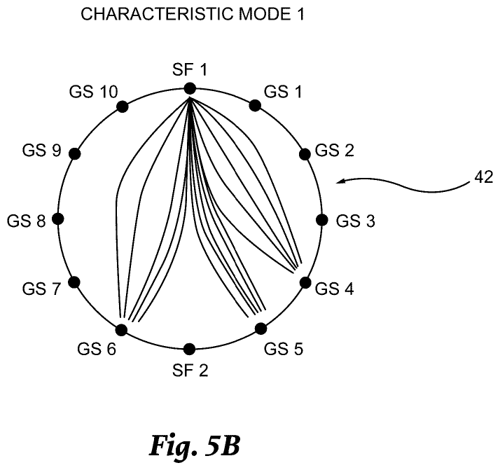

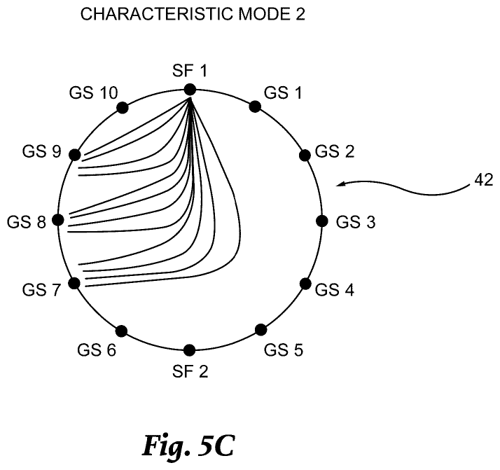

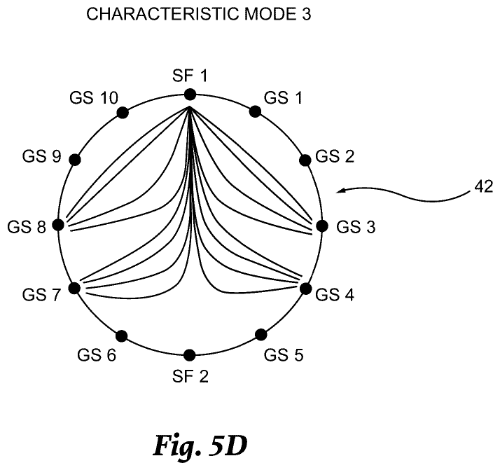

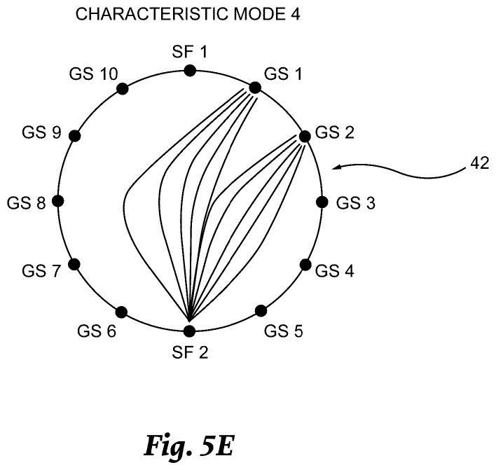

Referring to FIG. 5A, a table lists the open/closed settings of the ground switches GS1-GS10 for a first embodiment or configuration of the lower housing antenna 34, which provides four (4) characteristic modes, each have a single resonant frequency. For a first characteristic mode and resonant frequency of the lower housing antenna 34, the first signal feed SF1 is utilized, and the fourth ground switch GS4, the fifth ground switch GS5, and the sixth ground switch GS6 are each closed. (The switch accompanying the first signal feed SF1 is closed, and the switch accompanying the second signal feed SF2 is open.) For a second characteristic mode and resonant frequency, the first signal feed SF1 is utilized, and the seventh ground switch GS7, the eighth ground switch GS8, and the ninth ground switch GS9 are each closed. For a third characteristic mode and resonant frequency, the first signal feed SF1 is utilized, and the third ground switch GS3, the fourth ground switch GS4, the seventh ground switch GS7, and the eighth ground switch GS8 are each closed. For a fourth characteristic mode and resonant frequency, the second signal feed SF2 is utilized, and the first ground switch GS1 and the second ground switch GS2 are each closed. (The switch accompanying the first signal feed SF1 is open, and the switch accompanying the second signal feed SF2 is closed.)

Referring to FIGS. 5B, 5C, 5D, and 5E, for each of the respective characteristic modes and resonant frequencies, a schematic representation of the bottom plate 42 along with the signal feeds SF1, SF2 and the ground switches GS1-GS10 is shown. Also shown is a plurality of curved lines illustrating various paths on the bottom plate 42 along which the electronic signal current flows between the first signal feed SF1 or the second signal feed SF2 and the closed ground switches GS1-GS10 for each characteristic mode. Specifically, the electronic signal current paths between the first signal feed SF1 and the fourth ground switch GS4, the fifth ground switch GS5, and the sixth ground switch GS6 for the first characteristic mode are shown in FIG. 5B, the electronic signal current paths between the first signal feed SF1 and the seventh ground switch GS7, the eighth ground switch GS8, and the ninth ground switch GS9 for the second characteristic mode are shown in FIG. 5C, the electronic signal current paths between the first signal feed SF1 and the third ground switch GS3, the fourth ground switch GS4, the seventh ground switch GS7, and the eighth ground switch GS8 for the third characteristic mode are shown in FIG. 5D, and the electronic signal current paths between the second signal feed SF2 and the first ground switch GS1 and the second ground switch GS2 for the fourth characteristic mode are shown in FIG. 5E.

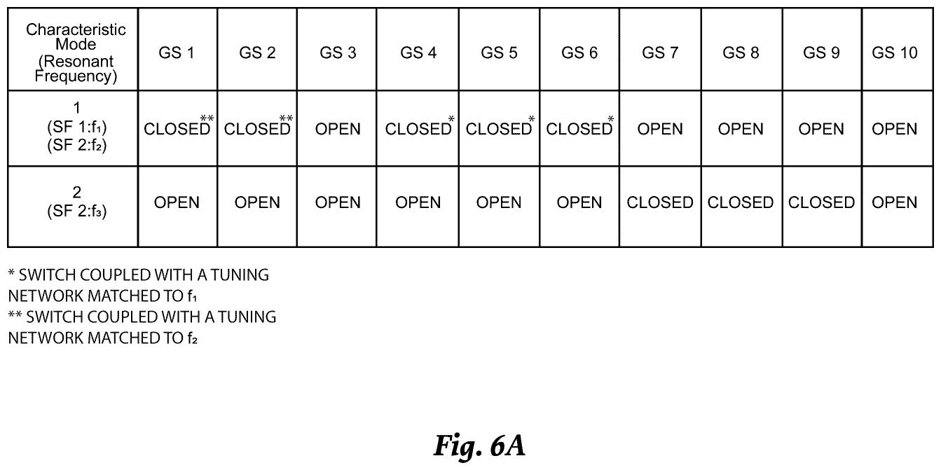

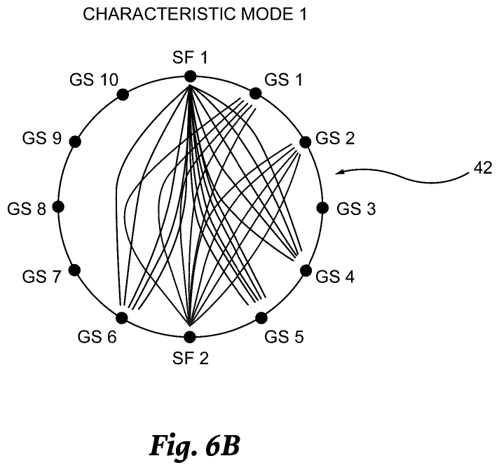

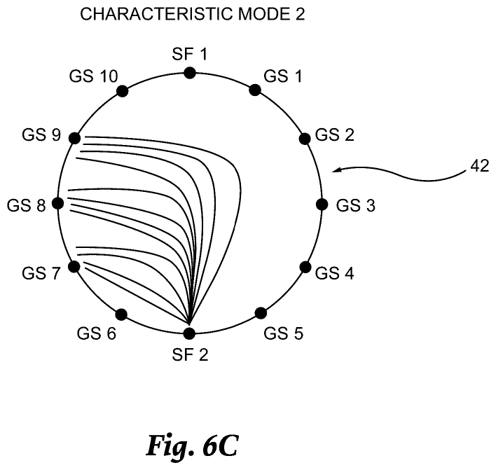

Referring to FIG. 6A, a table lists the open/closed settings of the ground switches GS1-GS10 for a second embodiment or configuration of the lower housing antenna 34, which provides two (2) characteristic modes, with the first characteristic mode having two (2) resonant frequencies, and the second characteristic mode having a single resonant frequency. For the first characteristic mode having a first resonant frequency, the first signal feed SF1 is utilized, and the fourth ground switch GS4, the fifth ground switch GS5, and the sixth ground switch GS6 are each closed. In addition, the tuning network 30 associated with each of the fourth ground switch GS4, the fifth ground switch GS5, and the sixth ground switch GS6 is utilized and tuned (or filtered) to the first resonant frequency. For the first characteristic mode having a second resonant frequency, the second signal feed SF2 is utilized, and the first ground switch GS1 and the second ground switch GS2 are each closed. In addition, the tuning network 30 associated with each of the first ground switch GS1 and the second ground switch GS2 is utilized and tuned (or filtered) to the second resonant frequency. For the second characteristic mode having a third resonant frequency, the second signal feed SF2 is utilized, and the seventh ground switch GS7, the eighth ground switch GS8, and the ninth ground switch GS9 are each closed.

Referring to FIGS. 6B and 6C, for each of the respective characteristic modes and resonant frequencies, a schematic representation of the bottom plate 42 along with the signal feeds SF1, SF2 and the ground switches GS1-GS10 is shown. Curved lines illustrating various paths on the bottom plate 42 along which the electronic signal current flows between the first signal feed SF1 or the second signal feed SF2 and the closed ground switches GS1-GS10 for each characteristic mode are shown. Specifically, the electronic signal current paths for the first characteristic mode between the first signal feed SF1 and the fourth ground switch GS4, the fifth ground switch GS5, and the sixth ground switch GS6 and between the second signal feed SF2 and the first ground switch GS1 and the second ground switch GS2 are shown in FIG. 6B, and the electronic signal current paths between the second signal feed SF2 and the seventh ground switch GS7, the eighth ground switch GS8, and the ninth ground switch GS9 for the second characteristic mode are shown in FIG. 6C.

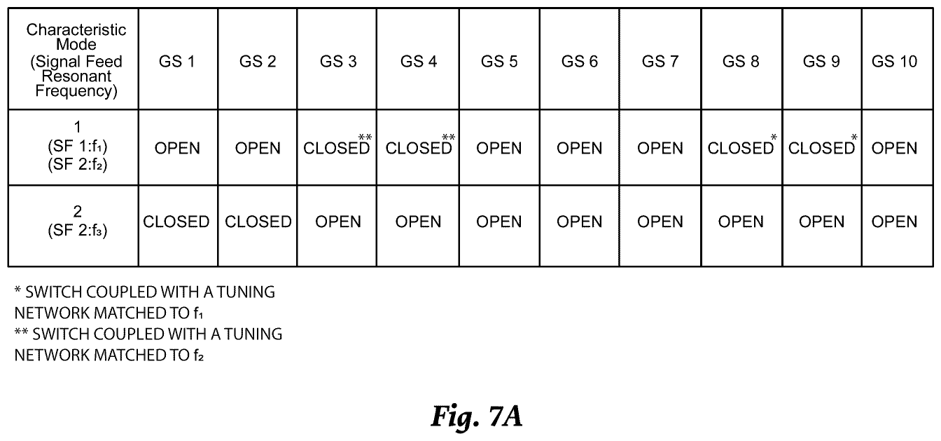

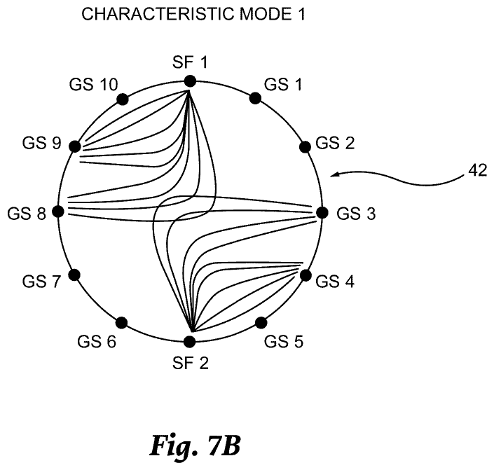

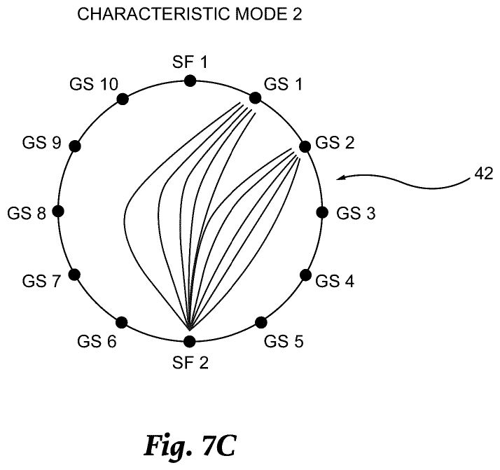

Referring to FIG. 7A, a table lists the open/closed settings of the ground switches GS1-GS10 for a third embodiment or configuration of the lower housing antenna 34, which provides two (2) characteristic modes, with the first characteristic mode having two (2) resonant frequencies, and the second characteristic mode having a single resonant frequency. For the first characteristic mode having a first resonant frequency, the first signal feed SF1 is utilized, and the eighth ground switch GS8 and the ninth ground switch GS9 are each closed. In addition, the tuning network 30 associated with each of the eighth ground switch GS8 and the ninth ground switch GS9 is utilized and tuned (or filtered) to the first resonant frequency. For the first characteristic mode having a second resonant frequency, the second signal feed SF2 is utilized, and the third ground switch GS3 and the fourth ground switch GS4 are each closed. In addition, the tuning network 30 associated with each of the third ground switch GS3 and the fourth ground switch GS4 is utilized and tuned (or filtered) to the second resonant frequency. For the second characteristic mode having a third resonant frequency, the second signal feed SF2 is utilized, and the first ground switch GS1 and the second ground switch GS2 are each closed.

Referring to FIGS. 7B and 7C, for each of the respective characteristic modes and resonant frequencies, a schematic representation of the bottom plate 42 along with the signal feeds SF1, SF2 and the ground switches GS1-GS10 is shown. Curved lines illustrating various paths on the bottom plate 42 along which the electronic signal current flows between the first signal feed SF1 or the second signal feed SF2 and the closed ground switches GS1-GS10 for each characteristic mode are shown. Specifically, the electronic signal current paths between the first signal feed SF1 and the eighth ground switch GS8 and the ninth ground switch GS9 and between the second signal feed SF2 and the third ground switch GS3 and the fourth ground switch GS4 for the first characteristic mode are shown in FIG. 7B, and the electronic signal current paths between the second signal feed SF2 and the first ground switch GS1 and the second ground switch GS2 for the second characteristic mode are shown in FIG. 7C.

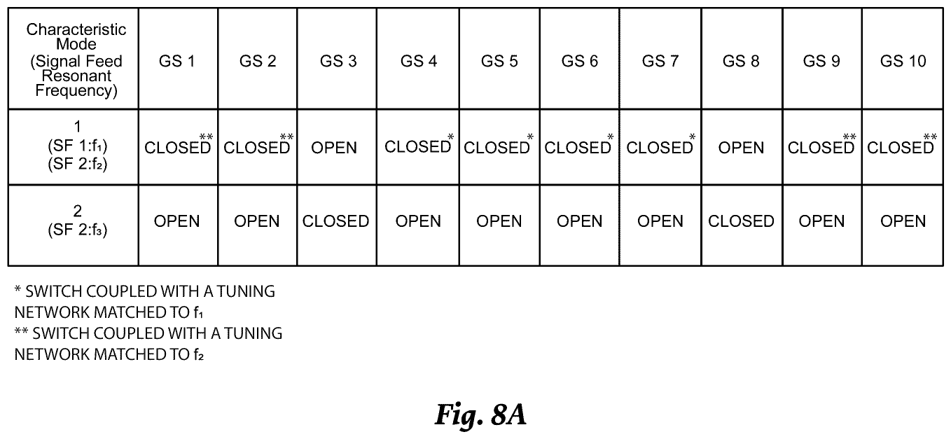

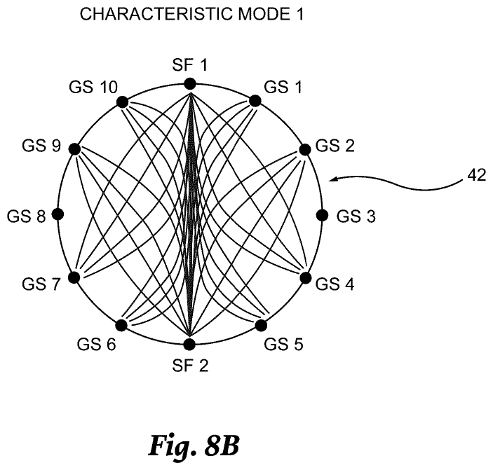

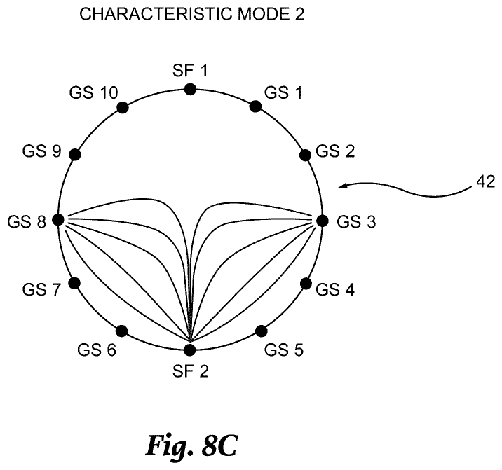

Referring to FIG. 8A, a table lists the open/closed settings of the ground switches GS1-GS10 for a fourth embodiment or configuration of the lower housing antenna 34, which provides two (2) characteristic modes, with the first characteristic mode having two (2) resonant frequencies, and the second characteristic mode having a single resonant frequency. For the first characteristic mode having a first resonant frequency, the first signal feed SF1 is utilized, and the fourth ground switch GS4, the fifth ground switch GS5, the sixth ground switch GS6, and the seventh ground switch GS7 are each closed. In addition, the tuning network 30 associated with each of the listed ground switches GS4-GS7 is utilized and tuned (or filtered) to the first resonant frequency. For the first characteristic mode having a second resonant frequency, the second signal feed SF2 is utilized, and the first ground switch GS1, the second ground switch GS2, the ninth ground switch GS9, and the tenth ground switch GS10 are each closed. In addition, the tuning network 30 associated with each of the listed ground switches GS1, GS2, GS9, GS10 is utilized and tuned (or filtered) to the second resonant frequency. For the second characteristic mode having a third resonant frequency, the second signal feed SF2 is utilized, and the third ground switch GS3 and the eighth ground switch GS8 are each closed.

Referring to FIGS. 8B and 8C, for each of the respective characteristic modes and resonant frequencies, a schematic representation of the bottom plate 42 along with the signal feeds SF1, SF2 and the ground switches GS1-GS10 is shown. Curved lines illustrating various paths on the bottom plate 42 along which the electronic signal current flows between the first signal feed SF1 or the second signal feed SF2 and the closed ground switches GS1-GS10 for each characteristic mode are shown. Specifically, the electronic signal current paths between the first signal feed SF1 and the fourth ground switch GS4, the fifth ground switch GS5, the sixth ground switch GS6, and the seventh ground switch GS7 and between the second signal feed SF2 and the first ground switch GS1, the second ground switch GS2, the ninth ground switch GS9, and the tenth ground switch GS10 for the first characteristic mode are shown in FIG. 8B, and the electronic signal current paths between the second signal feed SF2 and the third ground switch GS3 and the eighth ground switch GS8 for the second characteristic mode are shown in FIG. 8C.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as an FPGA, to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as communication elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112 (f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A wrist-worn electronic device comprising:
a housing including a circumferential side wall, a bezel positioned above an upper surface of the side wall, and a bottom plate positioned below a lower surface of the side wall, the bezel and the bottom plate each at least partially formed from electrically conductive material;
a plurality of ground switches, each ground switch:
being selectively configurable between a first state in which the ground switch is open and a second state in which the ground switch is closed,
being positioned at a respective one of a plurality of ground locations along a perimeter of the bottom plate, and
configured to make an electrical connection between the bottom plate and electrical ground when the ground switch is closed; and
a lower housing antenna configured to operate at a respective one of a plurality of lower housing antenna frequencies, the lower housing antenna formed at least in part by a respective one of a plurality of signal feeds and a respective one of a plurality of groups of the ground switches, each signal feed being positioned at a respective one of a plurality of signal feed locations along the perimeter of the bottom plate.

2. The wrist-worn electronic device of claim 1, wherein the lower housing antenna frequency varies according to a respective one of a plurality of combinations of the signal feed and the group of ground switches.

3. The wrist-worn electronic device of claim 1, wherein the signal feeds include a first signal feed positioned at a first signal feed location and a second signal feed positioned at a second signal feed location that is 180 degrees apart from the first signal feed location.

4. The wrist-worn electronic device of claim 3, wherein the lower housing antenna operates at a first lower housing antenna frequency when the lower housing antenna is formed at least in part by the first signal feed and a first group of ground switches, operates at a second lower housing antenna frequency when the lower housing antenna is formed at least in part by the first signal feed and a second group of ground switches, operates at a third lower housing antenna frequency when the lower housing antenna is formed at least in part by the first signal feed and a third group of ground switches, and operates at a fourth lower housing antenna frequency when the lower housing antenna is formed at least in part by the second signal feed and a fourth group of ground switches.

5. The wrist-worn electronic device of claim 1, wherein the ground switches include a first five of the ground switches evenly spaced apart from one another along a first half of the perimeter of the bottom plate and a second five of the ground switches evenly spaced apart from one another along a second half of the perimeter of the bottom plate.

6. The wrist-worn electronic device of claim 1, further comprising a processor configured to set the state of each ground switch according to a respective one of the lower housing antenna frequencies of operation of the lower housing antenna.

7. The wrist-worn electronic device of claim 1, further comprising an upper housing antenna configured to operate at a respective one of a plurality of upper housing antenna frequencies, the upper housing antenna formed at least in part by at least a portion of the bezel.

8. The wrist-worn electronic device of claim 7, wherein the upper housing antenna frequencies include a first upper housing antenna frequency in the global positioning system (GPS) L1 band with a center value of approximately 1575.42 megahertz (MHz) and a second upper housing antenna frequency in the GPS L5 band with a center value of approximately 1176.45 MHz.

9. A wrist-worn electronic device comprising:
a housing including a circumferential side wall, a bezel positioned above an upper surface of the side wall, and a bottom plate positioned below a lower surface of the side wall, the bezel and the bottom plate each at least partially formed from electrically conductive material;
a plurality of ground switches, each ground switch:
being selectively configurable between a first state in which the ground switch is open and a second state in which the ground switch is closed,
being positioned at a respective one of a plurality of ground locations along a perimeter of the bottom plate, and
configured to make an electrical connection between the bottom plate and electrical ground when the ground switch is closed; and
a lower housing antenna configured to operate at a first lower housing antenna frequency and at a second lower housing antenna frequency simultaneously, the lower housing antenna formed by a first signal feed, a second signal feed, and a first group of ground switches, each signal feed being positioned at a respective one of a plurality of signal feed locations along the perimeter of the bottom plate.

10. The wrist-worn electronic device of claim 9, wherein the lower housing antenna is configured to operate at a third lower housing antenna frequency, the lower housing antenna formed by the second signal feed and a second group of ground switches.

11. The wrist-worn electronic device of claim 9, wherein a first subset of the first group of ground switches is coupled with a first tuning network tuned to the first lower housing antenna frequency.

12. The wrist-worn electronic device of claim 11, wherein a second subset of the first group of ground switches is coupled with a second tuning network tuned to the second lower housing antenna frequency.

13. The wrist-worn electronic device of claim 9, wherein the ground switches include a first five of the ground switches evenly spaced apart from one another along a first half of the perimeter of the bottom plate and a second five of the ground switches evenly spaced apart from one another along a second half of the perimeter of the bottom plate.

14. The wrist-worn electronic device of claim 13, further comprising a processor configured to set the state of each ground switch according to the one or more lower housing antenna frequencies of operation of the lower housing antenna.

15. The wrist-worn electronic device of claim 9, further comprising an upper housing antenna configured to operate at a respective one of a plurality of upper housing antenna frequencies, the upper housing antenna formed at least in part by at least a portion of the bezel.

16. The wrist-worn electronic device of claim 15, wherein the upper housing antenna frequencies include a first upper housing antenna frequency in the global positioning system (GPS) L1 band with a center value of approximately 1575 megahertz (MHz) and a second upper housing antenna frequency in the GPS L5 band with a center value of approximately 1176 MHz.

17. A wrist-worn electronic device comprising:
a housing including a circumferential side wall, a bezel positioned above an upper surface of the side wall, and a bottom plate positioned below a lower surface of the side wall, the bezel and the bottom plate each at least partially formed from electrically conductive material;
a plurality of ground switches, each ground switch:
being selectively configurable between a first state in which the ground switch is open and a second state in which the ground switch is closed,
being positioned at a respective one of a plurality of ground locations along a perimeter of the bottom plate, and
configured to make an electrical connection between the bottom plate and electrical ground when the ground switch is closed;
a lower housing antenna configured to operate at a respective one or more of a plurality of lower housing antenna frequencies, the lower housing antenna formed at least in part by a respective one or more of a plurality of signal feeds and a respective one of a plurality of groups of the ground switches, each signal feed being positioned at a respective one of a plurality of signal feed locations along the perimeter of the bottom plate; and
an upper housing antenna configured to operate at a respective one of a plurality of upper housing antenna frequencies, the upper housing antenna formed at least in part by at least a portion of the bezel.

18. The wrist-worn electronic device of claim 17, further comprising a processor configured to set the state of each ground switch according to the one or more lower housing antenna frequencies of operation of the lower housing antenna.

19. The wrist-worn electronic device of claim 17, wherein the ground switches include a first five of the ground switches evenly spaced apart from one another along a first half of the perimeter of the bottom plate and a second five of the ground switches evenly spaced apart from one another along a second half of the perimeter of the bottom plate.

20. The wrist-worn electronic device of claim 17, wherein
a first subset of a first group of ground switches is coupled with a first tuning network tuned to a first lower housing antenna frequency, and
a second subset of the first group of ground switches is coupled with a second tuning network tuned to a second lower housing antenna frequency.
